(19) United States
(12) Patent Application Publication
(10) Pub. No.: US 2006/0117030 A1
(43) Pub. Date: Jun. 1, 2006

(54) Computer-based intelligence method and apparatus for assessing selected subject-area problems and situations

(75) Inventors: Stephen Jay Datena, Portland, OR (US); Bart Eugene Lonchar, Portland, OR (US)

Correspondence Address: ROBERT D. VARITZ, P.C., 4915 SE 33RD PLACE, PORTLAND, OR, 97202, US

(73) Assignee: Lifecom, Inc.

(21) Appl. No.: 10/999,045

(22) Filed: Nov. 29, 2004

(51) Int. Cl. G06F 7/00

(52) U.S. Cl. 707/100

(57) ABSTRACT

A computer-based method and apparatus for assessing problems and situations in a defined knowledge domain, employing both (a) an inferential database of elemental data components, as domain-wide as possible, which are relevant to the domain, and (b) periodic statistical reviews of reported Assessment results in relation to that database to establish the certainty levels of such results. The invention employs nonlinear assessment techniques likenable to human reasoning, and thereby, as well as in other ways, conducts Assessment tasks in a manner that differentiates it from conventional, machine-based, linear problem resolution.

### BACKGROUND AND SUMMARY OF THE INVENTION

This application relates to a general purpose method and apparatus which employs a unique knowledge engine, and an associated unique library (and other) structure, to perform focused Assessments and diagnoses of various problems and situations. In particular, it discloses such an invention which strongly mimics the natural human thought process, and which is endowed with a powerful interactive and adaptive capability to grow and “learn” in every subject area to which its “attention” is directed. It is usable in all subject areas, or domains, of knowledge. Even more specifically, the invention addressed herein constitutes an improvement over and in relation to the invention disclosed in a predecessor and currently pending U.S. patent application Ser. No. 10/367,302, filed by us on Feb. 14, 2003 for “Computer-Based Intelligence Method and Apparatus for Assessing Selected Subject-Area Problems and Situations”. As will be seen, this improvement relates to the significant introduction of certain mathematical calculations performed on what we refer to as numerically assigned, scalar addend values that are attached to certain data (elemental data points, or EDPs) employed in the practice of the invention to achieve reportable “Assessment” results. Use of this improvement appreciably enhances the characters of output-reported Assessments resulting from practice of the invention.

For the purpose of illustration herein, a preferred embodiment of, and a manner of practicing, the invention are described herein principally in the context and knowledge domain of medical diagnosis.

The underpinning core of the present invention, restated herein from the disclosure which is contained in the above referred to co-pending application, marks a significant departure from conventional, so-called artificial intelligence systems and processes. It offers a notable opportunity to fulfill the long-standing desire to link the processing power of a computer to an algorithmic approach which truly patterns (problem-/and situation-Assessment) performance closely to the ways in which the human mind actually processes such activity. This “core-provided” opportunity now stands with an enhanced status, as will be disclosed below herein, on account of fresh, additional discovery of the added value of performing certain important augmentive mathematical calculations which lead to improved confidence about achieved Assessment results.

With this desire held in mind, conventional artificial intelligence machines and methods have two general limitations. First of all, they are usually based upon linear decision processes. Secondly, they tend to be designed around specific applications, and are especially so designed in such a manner that the particular application per se dictates the architecture of the associated system and methodology. They have a strong singular focus. Linear-decision models, the conventional landscape, involve embedded data, in the sense that the applicable data structure is part of the decision-making architecture itself. This condition limits the possible outcomes of assessment behavior, and requires a significant overhaul of a system and of its associated methodology every time that new data is incorporated therein. Such linear-decision architecture, which essentially is a rule-based architecture, limits flexibility because of the fact that a user must follow certain designed pathways, even if those pathways are not optimal for the particular problem at hand. Domain-specific applications suffer from similar problems, since the underlying architecture therein is restricted by domain-specific data sets.

The system and methodology of the present invention, as will be seen, overcome all of these limitations, and provide a functionally superior, non-rule-based, model of human-mimicking machine intelligence, now enhanced in relation to our predecessor work by the introduction of special mathematical calculations. In accordance with implementation and practice of core features of the present invention, data sets are totally modular. Changes can be made in the applicable knowledge repository without disrupting the fundamental, available Assessment processes in any way. This condition allows the system and methodology of this invention easily and readily to expand its fund of knowledge without any of the limitations that have restricted the scalability of previous, expert, artificial intelligence systems.

Basically, rules or knowledge-based systems, artificial intelligence systems, use ‘hard’ Boolean logic architectures. Such systems have utility but are hampered by their linearity and rigid knowledge structures—i.e. they contain data embedded within a process structure. To incorporate new data into such a structure requires a substantial re-write of the corresponding process, or processes. This becomes a large data-maintenance problem as complexity of a knowledge domain increases. Another limitation is that designers of such systems must anticipate all possible relationships within the relevant data set in order to field a reliable system. This can also be a limitation of classic neural network architectures.

Classic fuzzy logic, or Bayesian nodal systems, invariably depend upon statistical analysis. Numerous data propagation and maintenance issues are associated with such systems. There are two main limitations for practical decision support application. One, statistical relationships are not static within subject (or subject areas of interest). And two, statistical relationships themselves break down at the level of the individual. Presentation of statistical information to decision makers may actually complicate decision making. Systems using statistical methods are by definition limited in applicability in early warning situations or where ‘out of box’ thinking (recognition of low probability issues) is required in order to recognize instances where rare situations, conditions or threats may in fact be present

By way of further contrast with prior art artificial intelligence technology, and in terms of important offered advantages, the system and method of the present invention are not limited to operation in but a single knowledge domain. More specifically, the invented system and method can work universally in any knowledge discipline, can handle a large number of potential Assessment results with great ease and stability, and can rapidly and seamlessly perform complex Assessments involving thousands of data elements. It will not choke, even on massive, data-intensive issues. As will become apparent, the invention can readily be integrated for use with a wide variety of existing, knowledge-domain-associated relational databases, and within all operating environments, can perform with a remarkably “human ability” to alter the direction being taken during an Assessment operation based upon newly encountered data. Additionally, the system and methodology of the present invention offer the further advantages that the system and method: (a) essentially use natural-language text structure to communicate with users, thus making extensive user training unnecessary; (b) can receive and process input data without any concern or requirement for defined-order input; (c) will consider all available data each time that there is a “run” of Assessment behavior; (d) can link Assessment activities to documented research relating to any selected knowledge domain; and (e) can properly process both vague, minimal Assessments, as well as detailed Assessments.

The invention is scaleable, and is capable of embracing the full weight of any subject area. Uniquely, it links, as Assessment companions and “co-workers”, the worlds of both inference and statistical analysis. It can undertake an Assessment task with very modest and sketchy inquiry-input information delivered in any sequence or order. It can refine an Assessment task by directing inquiries to, and soliciting related responses from, a user, and can create sophisticated and tightly focused output Assessments, mathematically elevated in accuracy confidence, in a easily understandable natural-language manner (as just mentioned above).

The functional building blocks of the method and apparatus of this invention take the form of elemental and fundamental, inferential components which are referred to herein as elemental data points (EDPs mentioned above herein). Two types of such EDPs are employed. One is referred to as a simple EDP, and the other as a complex EDP. A simple EDP consists of a singular data component, such as the word “shoulder” in a medically focused embodiment of the invention. A complex EDP consists of the associated combination of a single problem type, such as the word “pain” (in the medical field), and at least one data component, such as the word “shoulder” just mentioned. As will be more fully explained shortly, FIG. 2 in the drawings, still to be described herein, verbally diagrams the anatomies of these two kinds of EDPs. As will be developed in discussion presented below, at a certain point and region of operation of the present invention, these EDPs, when associated with elements called result-associated Master Keys and Result Keys, also become associated with certain scalar values referred to herein as scalar addend values. Such addend values are directly associated with what we refer to as the predictive value contribution to a problem and/or situation Assessment. These addend values will be more fully described below in relation to the description of a result-associated Master Key.

These EDPs are lowest-common-denominator-type elements that relate to, and represent, a wide spectrum of characteristics (ultimately all that can be identified) which are relevant to the possibilities, variations and permutations of matters involving particular, selected subject areas, or domains. Put another way, each EDP permits no further relevant subdivision that will, during an Assessment process, enhance the capability for further problem and/or situation Assessment differentiation. Methodology practiced in accordance with the invention is employed to generate and organize such EDPs, and also to produce another category of elements referred to herein, as mentioned above, as Result Keys.

A Result Key, according to the invention, is a collection of EDPs that represent a unique presentation of an Assessment result that is known and documented, and which is assigned a particular degree, or level, of certainty (related to the scalar addend values mentioned earlier). A Result Key is thus a combination of EDPs that defines a reportable result with some reliable degree of either positive or negative certainty.

Result Keys are effectively “organized” into identifiable Master Keys, where each Master Key is effectively a collection of all EDP's that are associated with a single result, and Result Keys are identifiable collections of these EDPs which point, with different degrees of certainty, to that same result.

Within each result-associated Master Key, the EDPs therein have a hierarchy which relates essentially to their respective predictive power values regarding the result to which the Master Key relates (i.e., is associated). EDPs may range from having a high (or absolute) likelihood of predicting the correctness (positiveness) of that result, or to having a high (or absolute) likelihood of predicting the incorrectness (negativeness) of that same result. Those skilled in the art of a particular knowledge domain will fully understand, for each given result, what the relative-relationship hierarchy is among the EDPs that are associated with the Master Key for that result.

The scalar addend values assigned to EDPs in a result-associated Master Key are directly related to this hierarchy. They differ from one another in proportion to the relative differences of “positive and negative” result-predictive “powers” of the respective several EDPs in the Master Key. For example, an EDP(A) having a predictive power which points toward the positive correctness of a result which is twice that of another EDP(B) in the same Master Key, which other EDP also points toward the positive correctness of that same result, will be assigned a “positive” scalar addend numeric value which is twice that which assigned as a positive scalar addend numeric value to EDP(B). So, if the addend value given to EDP(B) is [50], that given to EDP(A) will be [100].

Similarly, different value levels of negative scalar addend numeric values will be proportioned and assigned to EDPs in the result-associated Master Key which point toward the incorrectness (negativeness) of the result associated with that Maser Key.

These scalar values are referred to herein as “addend” values because of the fact, as will be seen shortly, that they will be employed in mathematical “summing” calculations which are proposed in accordance with the present invention.

Another term employed herein is Assessment. An Assessment takes the form of a collection of EDPs, and it is an Assessment which, as will shortly be explained, is reviewed during practice of the invention to look for what are referred to herein as Result Key hits.

Another important element of a defined knowledge domain is referred to herein as a “problem type” (mentioned briefly above). As was stated earlier, so-called complex EDPs are made up of one or more data components grouped in the context of a problem type. A problem type is a distinct category of information, organized hierarchically for classifying a problem for a knowledge domain in a manner that mimics the way experts in that knowledge domain think of problems and situations. Ideally, the universe of problem types will be inclusive of all known problems within a particular knowledge domain. Problem types offer a convenient and effective entry point for users of the system and methodology of this invention for describing the problems and situations that they are wishing to have assessed. TABLE I below diagrams the relationships of EDPs, problem types, and data components:

TABLE I

| | Problem Type | Data Component |
|---|---|---|
| Simple EDP | n/a | Patient Age Band: 30-49 |
| Complex EDP | Pain | Location: Shoulder |
| | | Onset: Sudden |
| | | Frequency: Constant |

Associated with each EDP, in accordance with the invention, are two usage indicators which indicate whether the EDP (a) can be directly employed as part of a Result Key, and/or (b) whether the EDP can be used as part of a reported Assessment. TABLE II immediately below generally shows how such indicators can exist:

TABLE II

| | RESULT | ASSESSMENT | |
|---|---|---|---|
| | USAGE | USAGE | |
| Type | INDICATOR | INDICATOR | SIGNIFICANCE |
| Classifications where | Y | Y | This would be considered a |
| the associated data | | | “normal” complex component. |
| components must be | | | |
| provided in the context | | | |
| of a problem type. | | | |
| | Y | N | This situation would be used to preserve a |
| | | | normalized view of complex components in order |
| | | | for the components to support shortcuts. |
| | N | Y | This represents complex data components that |
| | | | can be added to an assessment for documentation |
| | | | only, but are not considered by the adaptive |
| | | | knowledge engine. |
| | N | N | This is not a valid combination. |
| Classifications where | Y | Y | This would be considered a |
| a data component is | | | “normal” simple component |
| complete without being | | | |
| defined in the context | | | |
| of a problem type | | | |
| | Y | N | This would be used to preserve a normalized view |
| | | | of simple components in order for the components |
| | | | to support shortcuts. |
| | N | Y | This would be used for simple components that |
| | | | can be added to an assessment for documentation |
| | | | only, but are not considered by the adaptive |
| | | | knowledge engine. |
| | N | N | This is not a valid combination. |
| Classification that | Y | Y | This is generally not a valid combination because |
| represent syndromes, | | | these highly granular components are only |
| which are single data | | | accessible via the refinement process of the |
| components that | | | adaptive knowledge engine. |
| represent a highly | | | |
| granular complex set | | | |
| of characteristics. | | | |
| | Y | N | This is the typical scenario for syndromes and |
| | | | other special simple components. This allows |
| | | | keys to be built for them yet their inclusion in an |
| | | | assessment is done outside the initial data capture |
| | | | process, with processes such as refinement, |
| | | | default components, etc. |
| | N | Y | This is not a common scenario, but could be used |
| | | | to capture highly granular data for documentation |
| | | | purposes only, without being considered by the |
| | | | adaptive knowledge engine. |
| | N | N | This is not a valid combination. |

The creation and use of such EDPs and Result Keys enables a still further important feature of the invention which is that, during an Assessment operation, the system and methodology of this invention can approach the task of arriving at a reportable result by noticing the absence of some quality or characteristic that relates (a) to the original input inquiry data, and/or (b) to responses which are received from a user during what is more fully described below as an Assessment refinement process. For example, in the field of medicine, a field wherein the invention has been found to offer particular utility, and which is employed herein as a model to illustrate the invention, the absence of some particular characteristic of good health can indicate the impending emergence of some infirmity. As a consequence, the invention offers an impressive opportunity, in this field, to give very early warnings about the onsets of potential medical problems.

In another field, such as, for example, the field of materials processing, the method and apparatus of the invention might notice the absence of a stream of certain processing-related data, which absence might indicate the occurrence of a failed processing step.

Importantly, the inferential database employed according to the invention is independent of the algorithm(s) employed by the knowledge engine during Assessment activity. This independence strongly supports the open versatility with which the structure and methodology of the invention perform.

Three of many powerful aspects of the system and methodology of this invention, in addition to the newly discovered introduction of certain mathematical value calculations, are: (a) that inferential, elemental data components are constructed to possess the characteristics and qualities mentioned above; (b) that a practice referred to herein as relevance short-cutting (shortly to be described) fuels remarkable efficiency in the Assessment processing which is performed by the knowledge engine that is part of the system; and (c) that the practice of such short-cutting enables “lateral” investigations which cut across and embrace plural problem types, and even plural problem types that reside in plural, analogous knowledge domains. This unique “lateral” capability especially models human cognitive thinking, and avoids the linear decision-making trap which confines the capabilities of conventional artificial intelligence systems and methods.

The process and practice of so-called short-cutting relates to how data components are handled according to the invention. A short-cut data component, also referred to herein as a normalized data component, is a single data component which is associated with one problem type, and which acts as a surrogate for relevant, plural, other data components (non-normalized data components) that are associated with the same problem type, and/or with another, or plural other, problem type(s). Assessment relevance is the principal context within which short-cuts are created. Short-cuts significantly enhance the performance of the structure and methodology of this invention, as will be seen.

A simple illustration given immediately herebelow will illustrate the concept of relevance short-cutting. This illustration is set in the context of an Assessment operation wherein the user is entering information regarding the lateral orientation of a medical phenomenon/issue. EDP entry value choices include: Left Side; Right Side; Both Sides; One Side Only—a total of four EDP possibilities. Relevance short-cutting normalization of this nominally four-EDP population causes the “values” of “Left Side” and “Right Side” to be representable also as “One Side Only”. Hence, the two values “Left Side” and “Right Side”, which exists as definitive, plural individuals from a non-normalized point of view, are treated as the single, integrated value “One Side Only” from the normalized point of view. The importance of this multiple-to-singular short-cutting practice will be more fully discussed later herein.

A further important contribution of the present invention is that it employs statistical analysis, utilizing past system performances to enhance the confidence levels of results produced in subsequent (downstream) Assessments. During Assessment activity, the system and method of this invention implement refinement sub-processes which thoughtfully elicit additional guided input information to help close in on the best obtainable assessment result. Data obtained during Assessment performances are collected and stored in a manner whereby the knowledge engine in the system can perform statistical analysis to grow and improve the quality and effectiveness of the resident, underlying, inferential database which fuels system behavior.

Expressed briefly here in terminology and phraseology which will become more well understood shortly, when, during an Assessment process, a so-called Result Key is “hit” so as to lead, at least preliminarily, to a reportable Assessment result, EDP contents of the Result Key's associated Master Key are compared for content overlap with the EDP content in an associated Assessment collection of EDPs (this turns out to be a so-called EDP overlap), and the scalar addend values of the “overlapping EDPs” are employed in two mathematical sum calculations (one sum for positive addend values, and another sum for negative addend values) to arrive at what we refer to as a “power value, or values”. It is this power value, newly discovered by us, which offers a significant improvement over the Assessment-reporting performance of the predecessor invention embodiment described in the mentioned predecessor patent application.

In each domain of knowledge with respect to which the present invention is employed, there will typically be a relatively large plurality of Master Keys, each if which is specifically associated with a particular reportable outcome of a problem, or situation, Assessment activity. In the context of the domain of medical knowledge, the context in which the present invention is illustratively described herein, each such Master Key can be thought of as being associated with a different diagnosis to be reported as an outcome of an Assessment activity. As has been mentioned, each Master Key effectively takes the form of a specific collection of EDPs. Given this situation, it is entirely possible, and frequently the case, that the very same EDPs which make up what has been referred to above as a Result Key which is associated with a single specific Master Key, are also present in a very different Result Key which is associated with a different Master Key.

Another important feature of the present improvement invention involves the fact that when a Result Key “hit” occurs, the overlap comparison mentioned above is performed with respect to every Master Key which is linked with a Result Key containing, and fully defined by, the same collection of EDPs as the Result Key which initially generated such a hit. Through this approach, a reported outcome provided by operation of the present invention takes on and demonstrates a very high degree of sophistication and accuracy.

These and many other features and advantages that are offered by the present invention improvement will become now more fully apparent as the detailed description which follows is read in conjunction with the accompanying drawings.

### DESCRIPTION OF THE DRAWINGS

FIG. 1 is a block/schematic diagram of both the preferred system of, and the preferred manner of practicing, the present invention.

FIG. 2 presents, in text form, the structures of the two fundamental types of data-component building blocks (EDPs) employed in and by the invention.

FIG. 3 diagrams the significant and important practice of relevance short-cutting which is implemented by the invention.

FIG. 4 illustrates, in text-enhanced, block/schematic, Bachman-diagram form, the important, adaptable data-component matrix (library) which contributes appreciably to the utility of the invention.

FIG. 5 illustrates, also in text-enhanced, block/schematic, Bachman-diagram form, the likewise important, adaptable Result Key database (library) which co-functions with the component matrix in promoting the utility of the present invention.

FIGS. 6-9, inclusive, are Venn diagrams elaborating different, specific, illustrative Assessment closures toward an Assessment result as performed very fundamentally by the system and method of this invention. These figures illustrates foundation information regarding what is shown in FIGS. 12-16, inclusive, which figures (12-16) schematically and graphically demonstrate the mathematical calculations improvements proposed by the present invention.

FIG. 10 is a block/schematic diagram illustrating fundamental performance of the invention from the point of view of entry of a single data component, and the operative relationships between this entry and the subject matters of Results, Result Keys, Master Keys and Shortcutting.

FIG. 11 is a block/schematic diagram illustrating, again in a fundamental manner, one modified form of a system, and of a related methodology, that implement the invention in the setting of plural knowledge domains.

FIGS. 12-16, inclusive, collectively illustrate the mathematical calculation improvements referred to earlier herein which are offered by the present invention.

### DETAILED DESCRIPTION OF THE INVENTION

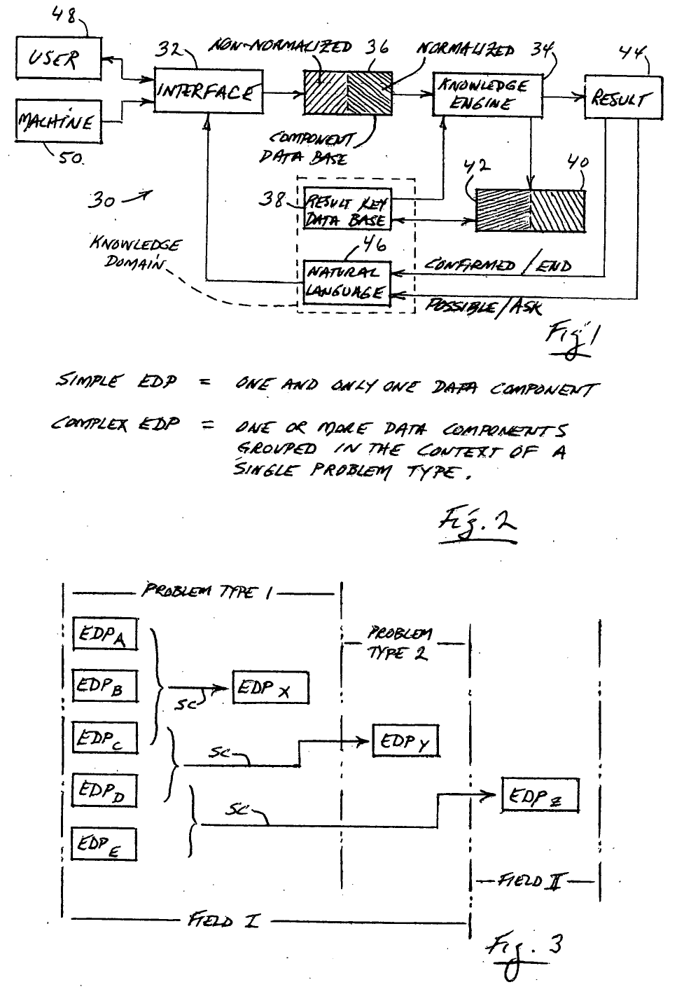

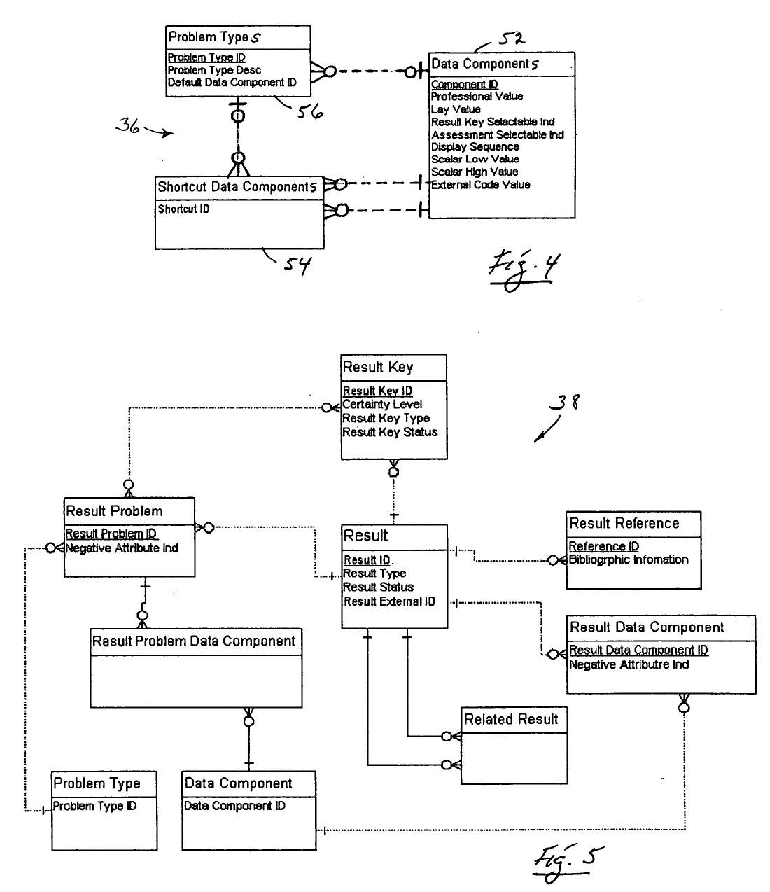

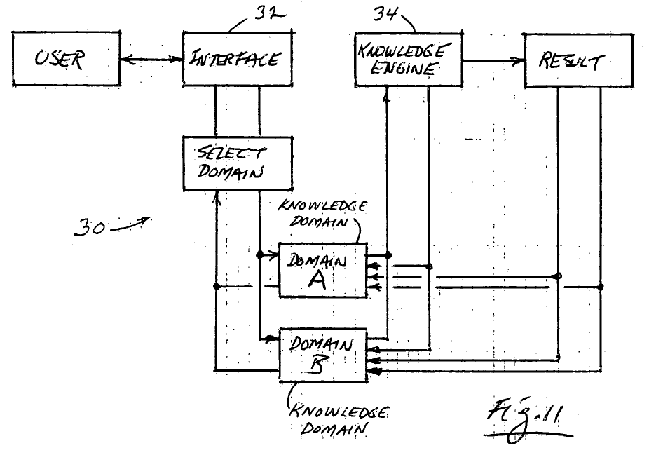

As is generally set forth above, FIGS. 1-11, inclusive, in the drawings describe underpinning fundamentals of the present invention which are also disclosed in the mentioned predecessor patent application and upon, and combined with, which, fundamental enhancing improvements have been made to complete the content of this invention. Description begins with discussion relating more specifically, therefore, to these eleven drawing figures.

Accordingly, and referring first of all to FIG. 1, indicated generally at 30 is a computer-based knowledge system (and methodology) which is (are) constructed and organized in accordance with the present invention to perform Assessments regarding problems and/or situations that relate to a particular defined field, or domain, of knowledge. As was mentioned earlier herein, system and methodology 30 will now be described in relation to the knowledge domain of medicine, though it should clearly be understood that the general structures of system and methodology 30, as illustrated in FIG. 1, are universal with respect to all selectable domains or fields of knowledge. Additionally, much of the invention description which now follows will be presented from a systemic rather than a methodological point of view. This systemic point of view will be understood to function as a fully enabling disclosure and description of the related, implemented methodology of the invention.

Included in system 30 are a communication interface 32, also called an input/output communication interface zone, a computer-based knowledge engine 34, also referred to herein as an output-Assessment-striving knowledge engine, a data-component matrix (or library) 36, a Result Key database (or library) 38, a statistical analysis region 40, an engine-run database (or library) 42, a result-assembling zone 44, and a natural-language output enabler 46. Interconnecting lines with arrowheads represent operative and communicative interconnections that exist, in accordance with the invention, between various ones of these several system and methodologic components.

At the left side of FIG. 1, two blocks, 48, 50 represent inputers of inquiry information that may be input the system in the context of requesting an Assessment regarding a problem and/or situation in the field of medicine. Block 48 specifically represents a human inquirer, and block 50 a machine (computer) inquirer. During system operation, both of these blocks, or only one of these blocks if only one is employed or involved, feed(s) input information directly into interface 32, and receives system-Assessment-result output information directly from this interface. Description will continue herein in the context of the human input (48) of information, etc. Interface 32 may take on any one of a number of conventional forms, such as a conventional web-based browser.

Knowledge engine 34 in system 30 takes the form of a conventional digital computer appropriately equipped with algorithms (a) for implementing Assessments based upon the contents of component matrix 36 and of Result Key database 38 (forming a part of an Assessment-accessible database) in relation to input information supplied to interface 32, (b) for conducting statistical analysis through cooperative interaction between blocks 40, 42, and (c) for implementing, via block 46, natural-language, outwardly-directed communication through interface 32 with, for example, user 48. As will be seen later in this discussion, it is engine 34, working with other blocks shown in FIG. 1, which performs the various mathematical calculation steps that play a significant role in the practice and structure of the present invention.

Block 44 is organized to carry (along with engine 34) the responsibility, during Assessment activity or at other times, and under the control of the knowledge engine, for determining whether a best-obtainable final result has been achieved, and if not, what sort or sorts of refinement questions ought to be directed through blocks 46, 32 to user 48. Such refinement behavior will be discussed more fully shortly.

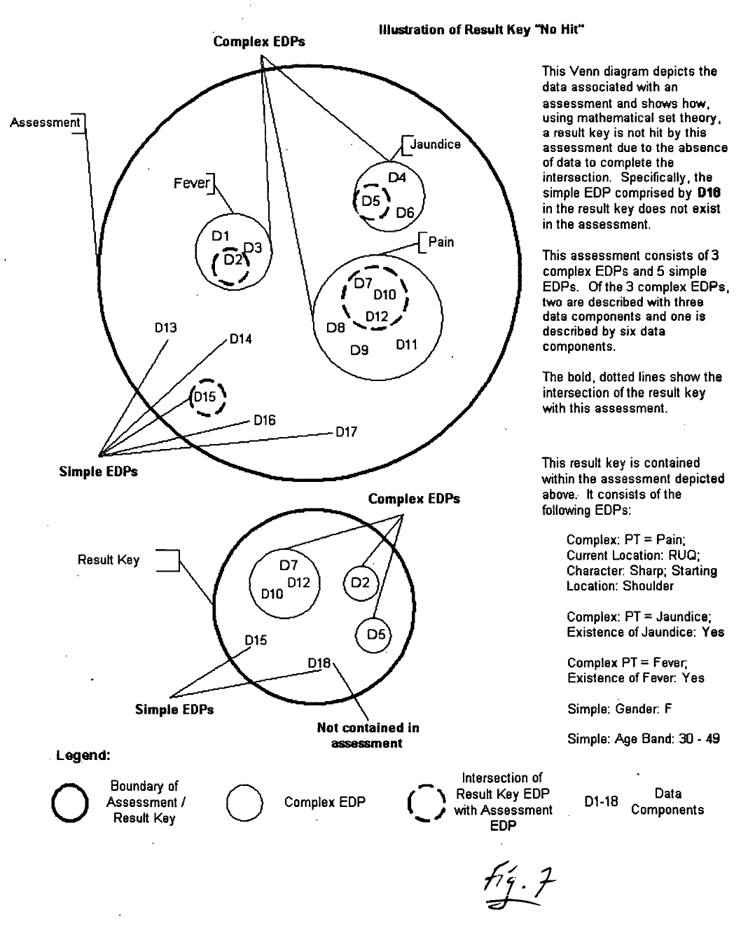

The internal constructions of component matrix 36, and of Result Key database 38, play key roles in enabling the human-cognitive behavioral capability of the system and methodology of this invention. These internal structures are detailed, respectively, in FIGS. 4 and 5 in the drawings, to which attention is now successively directed.

In FIG. 4, data-component matrix 36 is seen to be fully illustratable and describable with three, principal, interconnected blocks 52, 54, 56 which are labeled, respectively, “Data Components”, “Short-Cut Data Components”, and “Problem Types”. FIG. 4 herein is presented in the format of a conventional Bachman-diagram which includes a collection of functional blocks, interconnected by lines that have different appearance characteristics, with certain well-known graphical symbols placed appropriately near the ends of these lines where the lines connect with the blocks.

These lines and symbols are well known by those skilled in the art, and a reading of FIG. 4, along with an understanding of the natures of the contents of blocks 52, 54, 56, will fully enable the creation and use, according to the invention, of data-component matrix 36 for any selected domain of knowledge. Text within blocks 52, 54, 56 describes the characteristics and attributes, generally, of the contents therewithin, and the following graphical and textual Table III, in a modest-content way, further illustrates component matrix 36.

TABLE III
Medical Diagnosis

Problem Types:
Pain
Rash
Mass or Lump
Data Classifications/data Components:
Onset
Sudden
Gradual
Pain Characteristic
Sharp
Dull
Colic
Burning
Color
Red
Tan
Black

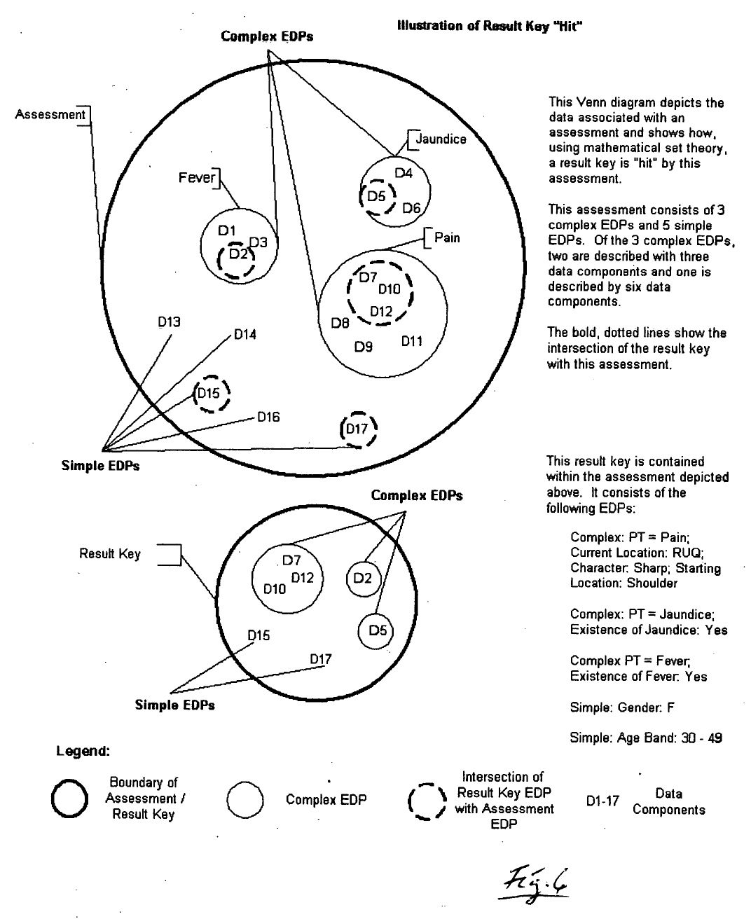

Focusing attention now on FIG. 3 along with FIGS. 1 and 4 and TABLE III, the nature of a short-cut, as proposed by the present invention, is illustrated graphically and in text in FIG. 3. As was mentioned briefly earlier, short-cuts employ the characteristic of relevance to associate a plurality of broad-based EDPs, which are associated with one common problem type within one knowledge domain, typically with another singular EDP. This “other” EDP can be associated (a) either with the same common problem type in the same knowledge domain, (b) with another problem type in the same knowledge domain, and/or (c) with another problem type which is in another knowledge domain. This special “other problem type”, and/or “other knowledge domain”, quality of a short-cut is what allows for significant lateral-Assessment processing in a manner which is very closely linked to normal human thinking. It is a key feature which distinguishes the structure and methodology of this invention from conventional “linear” artificial-intelligence structures and procedures. It is a feature which adds important flexibility, mobility, agility and efficiency to the performance and capability of the present invention.

Looking especially now to FIG. 1, one will observe that the “user side” of data-component matrix 36 “sees” the entire, large volume of non-normalized EDPs. This is important, inter alia, in allowing for a very high degree of unconstrained, free-form and free-flowing “dialog” between the system of this invention and a user. It prevents the significant conventional drawback, associated with known artificial intelligence systems, of early locking, channeling, and inflexible linearizing, of problem and situation Assessments.

On the other hand, however, the “knowledge-engine side” of matrix 36 sees only the smaller, most relevant set of EDPs, as determined through the above-described process of short-cutting. Engine operating efficiency benefits significantly from this situation.

Shifting attention now to FIGS. 1 and 5 together, FIG. 5 details, as was mentioned earlier, the structure of Result Key database 38. As is the case for previously described FIG. 4, FIG. 5 is, in its general layout, a conventional Bachman-diagram. This Bachman-diagram, along with the text material provided in it, fully describes to those skilled in the art the make-up and functionality of database 38. Accordingly, no further special elaboration of this database is deemed necessary.

As was noted earlier, still another important and significant offering of the present invention is its unique cooperative utilization of the “worlds” of both inference and statistics. This world is brought together in the special interactive behavior which takes place between knowledge engine 34, Result Key database 38, and blocks 40, 42.

Each time that engine 34 runs an Assessment process (still to be described), its performance results, including the EDPs and the Result Keys employed, are recorded and stored in block 42, the “engine-run” database. It is with regard to this performance-recorded, engine-run data that statistical analysis, and the special mathematical calculations which form important parts of the present invention, are conducted.

At any appropriate interval, such as at the completion of each Assessment “performance”, or after a certain number of completed Assessments, or completely at user selection and invocation, for several examples, engine 34, database 42, and statistical analysis region 40 cooperate to review stored performance data, and to analyze it to determine if any of several different kinds of Result Key modifications are in order. Statistical analysis region 40 may conveniently take the form of appropriate statistical-analysis software which is resident in knowledge engine 34, and which may be designed in a conventional manner to review stored Assessment-performance data. For example, such data may be reviewed, based upon previously determined Assessment results, to assess whether a particular Result Key's EDP content should be changed (enlarged, reduced, etc.), whether that Result Key's level of certainty as to its correctness should be changed, whether the Result Key should be eliminated, and so on. Such changes are “reported” to Result Key database 38, and thus may change the content of this database if such is an appropriate event. System 30 conveniently, and perhaps preferably, asks “permission” to invoke any such Result Key database revision. In this manner, the system and methodology of this invention continually self-improve to become more agile, effective and quickly accurate, much in the same way, at least in part, that the human mind adapts and grows from experience.

By utilizing statistical analysis in this helpful manner, the system and methodology of the invention uniquely integrate the management advantages of such analysis with the power and versatility of the inferential databases (EDPs) which form the data-component database and the Result Key database. Coupled with the innovation of relevance short-cutting, the invention clearly cleverly mimics significant aspects of normal human cognitive thinking.

The influential underpinning of these two databases offers an approach landscape to problem and situation evaluation and Assessment which is wide, rich, and common to normal avenues of reflective thinking. Short-cutting which can include relevance pointers to EDPs in the same or different problem areas, and to EDPs in the same or different knowledge domains or fields, prevents the constricting kind of linearization which characterizes conventional, machine, artificial-intelligence mannerisms. Such short-cutting also presents, or tends to present, to the knowledge engine for processing the most relevant and smallest-size set possible of foundation inferential data. With these databases clearly disconnected committedly from the underpinning processing algorithm(s), extensive flexibility and problem and situation evaluation are definitively offered and made present by the practice and implementation of the methodology and system of this invention. Reportable Assessment results, based upon inferentially founded result-keys which are assemblages of different EDPs (and EDP-associated), reviewable and modifiable under the thoughtful and watchful eyes of statistical analysis, and subjected to certain mathematical processes (still to be described) introduced by the present invention, grow progressively more accurate and sure with time.

Completing a description of what is shown in FIG. 1, attention is directed to blocks 34, 44 and 46.

Block 34, the knowledge engine, takes the form of a programmable digital computer, as was mentioned earlier, which is, inter alia, programmed to perform Assessments and the special mathematical calculations generally mentioned above, to report Assessment results, and, as just stated above, to aid in the statistical analysis of recorded performance data. It is also suitably programmed to perform focusing refinements regarding the inputting of data by, for example, a human user 48. And so, for example, if no confirmed, reportable Assessment result occurs during one run of Assessment behavior, the knowledge engine utilizes block 44 to direct a set of specific, multiple-choice questions (see the line marked “POSSIBLE/ASK” in FIG. 1) to the user, requesting, effectively, additional input information. These questions, which are directed to the user via natural-language block 46, are specifically related to the status of Assessment processing which has so far been undertaken. This is the important refinement process mentioned earlier. Block 46 assures that these questions are presented to a user in intuitive natural language.

During the performance of an Assessment procedure, and in relation, generally speaking, to EDP data which is provided by a user, knowledge engine 34 operates in accordance with the following basic “algorithmic instructions”. How the performance of these fundamental instructions is modified to accommodate the mentioned special mathematical determinations will be described later.

### The Algorithm

An assessment (Aₓ) consists of one to many EDPs, and can be thought of as a set:
Aₓ={EDP₁, EDP₂, . . . EDPₙ}
Each result key (in this case, RKₓ) consists of one to many EDPs, and can also be thought of as a set:
RKₓ={EDP₁, EDP₂, . . . EDPₙ}
The adaptive knowledge engine returns a result when the following formula is true:
AₓINTERSECT RKₓ=RKₓ
Simply stated, if the set of EDPs that comprise a Result Key are found within the EDPs that comprise the Assessment, then the result corresponding to the Result Key would be returned. It is important to note that the EDPs do not have to be identical to satisfy a Result Key hit. The critical factor is that each EDP that is part of a Result Key must either equal an EDP in the Assessment or be contained within an EDP in the Assessment (a subset).
The intersection of a Result Key's EDP with an Assessment's EDP must occur within a single EDP: It cannot span EDPs.

As will become more fully apparent shortly, the knowledge engine of this invention, practicing the mathematical calculation functionality proposed by the invention, can return a result which is either positive (yes, a certain condition probably, or definitely, exists), or negative (no, a certain condition probably, or definitely, does not exist).

At the beginning of what can be thought of as each Assessment procedure, or operation, wherein a result determination is to be assessed/evaluated, a “beginning Assessment” in the procedure is referred to herein as a preliminary, pre-reportable, result-associated Assessment. This preliminary Assessment lies “along the way”, so-to-speak, toward the creation of what is called a “reportable Assessment”.

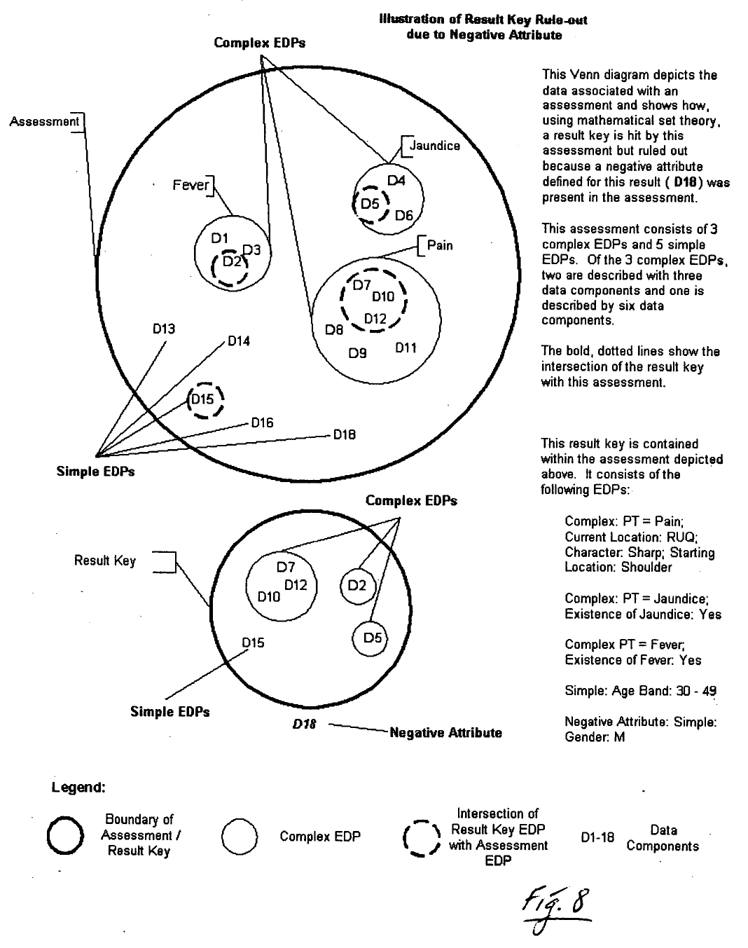

Continuing now with what is further shown in certain ones of the drawings, the four diagrams which make up FIG. 6-9, inclusive, are, as has already been mentioned, conventional Venn diagrams. To those generally skilled in the art, they are very self-explanatory regarding how the knowledge engine performs the above-described basic algorithm of the present invention. In particular, those who are skilled in the art will readily understand clearly from these illustrative performance diagrams just how knowledge engine 34 fundamentally performs an Assessment during its operation, under several, different, typically encounterable Assessment situations.

By way of brief summary, the four examples that are set forth in these four figures, furnished at this point without reference to the still to be discussed mathematical requirements proposed by the present invention, are based on a series of related medical diagnostic Assessments which involve, for illustration purposes, three complex EDPs and five simple EDPs. In the first example (FIG. 6), a Result Key is depicted which gets a “hit” on this Assessment. The Result Key consists of EDPs that represent the following scenario:

A female patient, age 30-49, inclusive, is experiencing sharp pain in the right upper quadrant that originated in the shoulder. This same patient is also experiencing fever and jaundice.

The Result Key is “hit” in this example because all of its EDPs are each completely contained within a single EDP in the overall assessment.

The second example (FIG. 7) illustrates a situation where a Result Key is not hit.

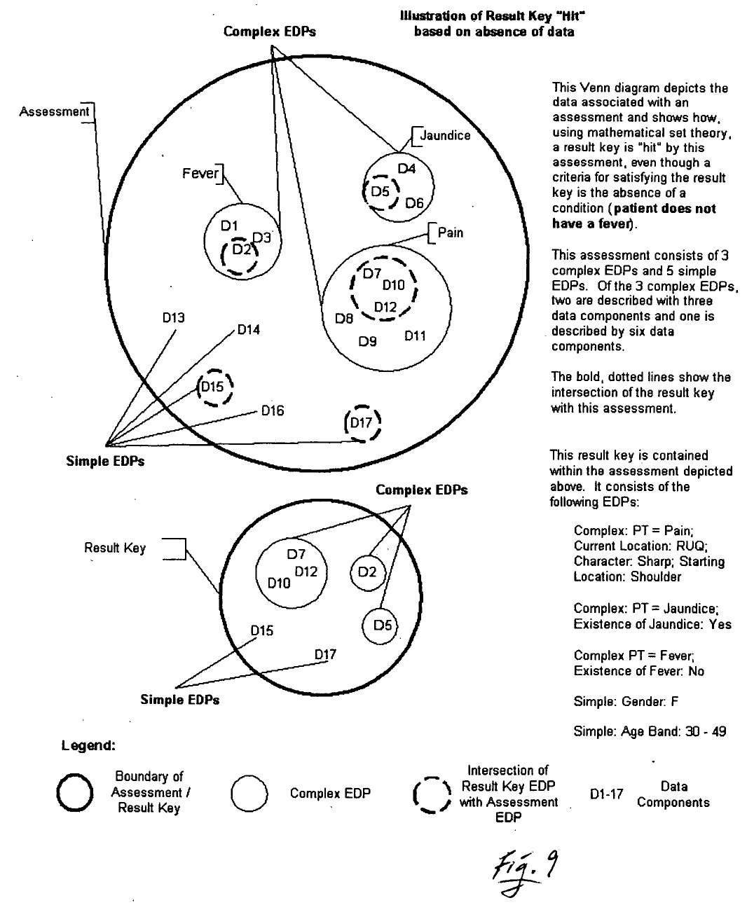

The third example (FIG. 8) pictures a case where a result is ruled out due to the existence of a negative attribute which has been presented and detected.

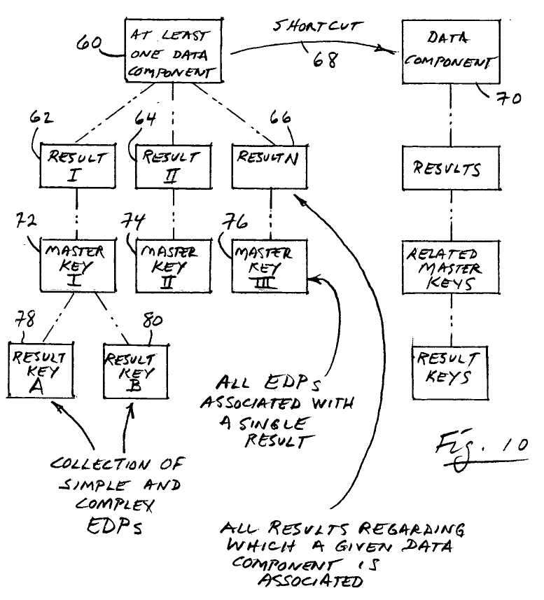

The last example (FIG. 9) illustrates a “hit” on a Result Key under circumstances where one EDP in that Result Key represents the absence of a particular condition.

The process of Assessment refinement mentioned above is now described. In this description, which includes Table IV, the letters AKE are employed to refer to knowledge engine 34.

The refinement process of the adaptive knowledge engine can be engaged during Assessment performance to lead the user to the final results (such as a reportable result-associated Assessment) by performing and analysis of the data already captured by the Assessment and the possible results based on that data.

The refinement process generates a series of candidate standardized data lists that are organized and presented to the user. The user can add or subtract any data points to/from the Assessment, and can resubmit the Assessment to the engine.

The candidate data lists generated by the adaptive knowledge engine consist of data points that perform one of two functions:

1. Help confirm a possible result that the engine has identified.

2. Rule out a possible result based by identifying data that is contraindicated.

A run of the AKE will yield the following:

1. Zero to many specific results.

2. Zero to many general category results.

3. One or more potential results organized in what is called a “result map”.

For each result known to the engine, there are three ways that refinement data can be generated for those results by the engine. These are:

1. Data points that would result in the satisfaction of a general category key for the result.

2. Data points that would result in the satisfaction of a high probability key or confirmed existence key for the result.

3. Data points that would contraindicate the result.

In addition, each result known to the AKE may have one or more “related results” that are results that share data points with the subject result and can be mistaken for the subject result.

By identifying the combinations of the types of results yielded by a run of the knowledge engine with the types of data points used for refinement, one can discover the distinct refinement algorithms that are used to produce refinement questions for an Assessment. These combinations and resulting algorithms are depicted in the following Table IV.

TABLE IV

| Output of AKE → | | General Category | |
|---|---|---|---|
| Data Points | Specific Results | Results | Potential Results |
| Ones that satisfy a | Refinement Algorithm 1: | Refinement Algorithm 2: | Refinement Algorithm 3: |
| general category key | Identify all EDPs for all | Identify all EDPs for all | Identify all EDPs for all |
| | related results (to a | related results (to a | potential results that |
| | specific result that was | general category result | participate in a general |
| | returned by the engine) | that was returned by the | category key for that |
| | that participate in a | engine) that participate | result. |
| | general category key. | in a general category | |
| | | key. | |
| Ones that satisfy a | Refinement Algorithm 4: | Refinement Algorithm 5: | Refinement Algorithm 6: |
| high probability key | Identify all EDPs for all | Identify all EDPs for all | Identify all EDPs for all |
| | related results (to a | related results (to a | potential results that |
| | specific result that was | general category result | participate in a high |
| | returned by the engine) | that was returned by the | probability key for that |
| | that participate in a high | engine) that participate | result. |
| | probability key. | in a high probability key. | |
| Ones that | Refinement Algorithm 7: | Refinement Algorithm 8: | Refinement Algorithm 9: |
| contraindicate the | Identify all EDPs for all | Identify all EDPs for all | Identify all EDPs for all |
| result. | related results (to a | related results (to a | potential results that |
| | specific result that was | general category result | contraindicate those |
| | returned by the engine) | that was returned by the | results. |
| | that are contraindicated. | engine) that are | |
| | | contraindicated. | |
| | Refinement Algorithm 10: | | |
| | Identify all EDP for | | |
| | each specific result | | |
| | returned that would | | |
| | contraindicate that | | |
| | result. | | |

If, due to insufficient data capture, the engine does not generate results, refinement cannot be invoked.

The results of refinement are organized by problem type for logical consideration.

When refinement is invoked, any or all of the refinement algorithms may be invoked. Which algorithms are invoked is a function of (1) the number and type of results generated for the Assessment at the point refinement is invoked, and (2) how the AKE is configured for the subject area. Some types of refinement may not apply to some subject areas.

Reviewing generally the overall methodology of the present invention described so far, and fundamentally in accordance with the pre-improvement version of this invention, and doing so in light of the systemic description which has largely occupied the text above, while different designers of a system and a methodology made in accordance with this invention might, and may, chose different starting approaches to making an Assessment, one suitable approach in the context of a single-problem-domain system, involves asking a user, as an opening question, for example, to identify the (or a) specific problem type which is associated with the problem and/or situation that has prompted the user to invoke system Assessment in the first place. FIG. 10 generally illustrates what occurs when a response to such an opening question takes the form of one of the simplest possible replies, such as a single data-component reply, like “existence of pain”, without more. Even the presence of a single EDP data-component can form what has been referred to above as a preliminary, pre-reportable, result-associated Assessment, en route, so-to-speak, through the launch of an Assessment procedure, to the creation of a final, reportable, result-associated Assessment.

After receipt of the “existence of pain” input response (Block 60 in FIG. 10) which response takes the form of a simple EDP, the computing structure of the invention makes an appropriate survey of the database content to identify all results “known” to the system to which the data component “existence of pain” relates (Blocks 62, 64, 66 in FIG. 10). The system thus responds to this simple, single-data-component response with an expansive “look” at the entire database of results. The system simultaneously responds (Line 68 in FIG. 10) to any relevant shortcutting which is associated with the “existence of pain” response, and if shortcutting exists, identifies one or more other data components (A) (Block 70 in FIG. 10) with respect to which it performs the same kind of expansive look (or looks) at its results database as was just described for the single input data component.

What next occurs, with respect to all results that have been identified by the process outlined above, is that the result-associated Master Key for each such result (Blocks 72, 74, 76) is examined with regard to its content which includes all EDPs that are associated with the particular result, organized, effectively, into different Result Keys (see Blocks 78, 80 that are associated with the Master Key represented by Block 72). Each such Result Key is a collection of EDPs which has been determined to point, with a particular degree of certainty, to the associated result.

When a Result Key is “hit” (see FIGS. 6 and 9), an Assessment report, along with any determined requests for refinement, are reported through block 32 (see FIG. 1) to the user.

Turning focused attention now toward the mathematical-calculation improvement which is offered specifically by the present invention, this will be described with particular reference made to different ones of FIGS. 12-16, inclusive, viewed along, as appropriate, with FIGS. 1-11, inclusive.

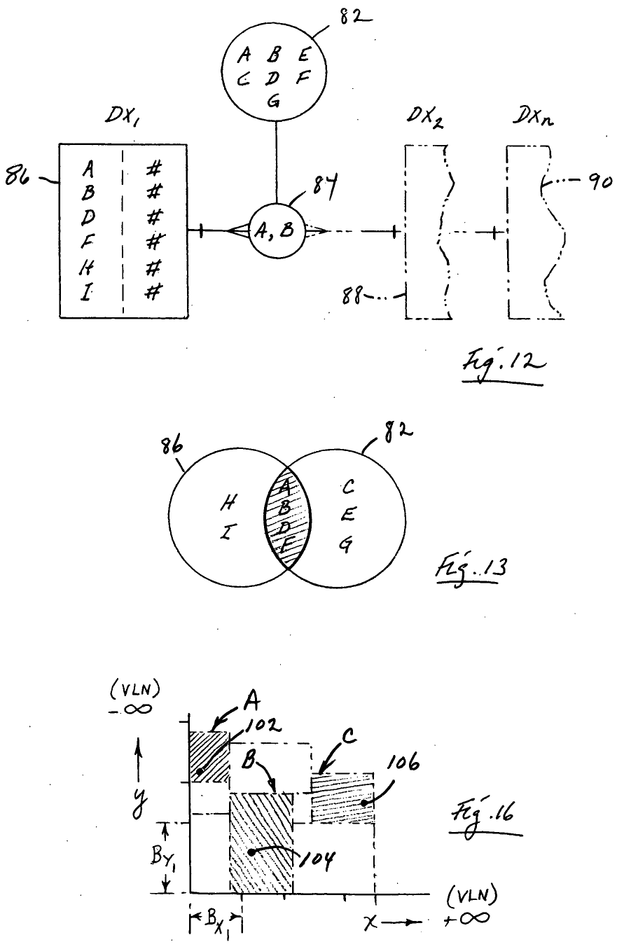

Beginning with FIGS. 12 and 13, indicated generally at 82 in FIG. 12 is what is referred to herein as an Assessment containing seven EDPs A, B, C, D, E, F and G. Through processing in accordance with the description of the invention given above herein, a Result Key 84 has been “hit”—this Result Key including EDPs A and B.

Shown at DX₁, DX₂ and DX_{N}, numbered 86, 88, 90, respectively, in FIG. 12, are three different Master Keys. The letters DX_{N} refer specifically to so-called diagnoses which are relevant to the knowledge domain of medicine. Result Key 84 is essentially slaved to Master Key 86, but it turns out that its EDPs, A and B, are also EDPs which make up two, specific, different Result Keys, one each for the two Master Keys 88 and 90. In other words, the EDPs which make up Result Key 84 also define specific, different Result Keys that are within the EDP contents respectively of Master Keys 88 and 90.

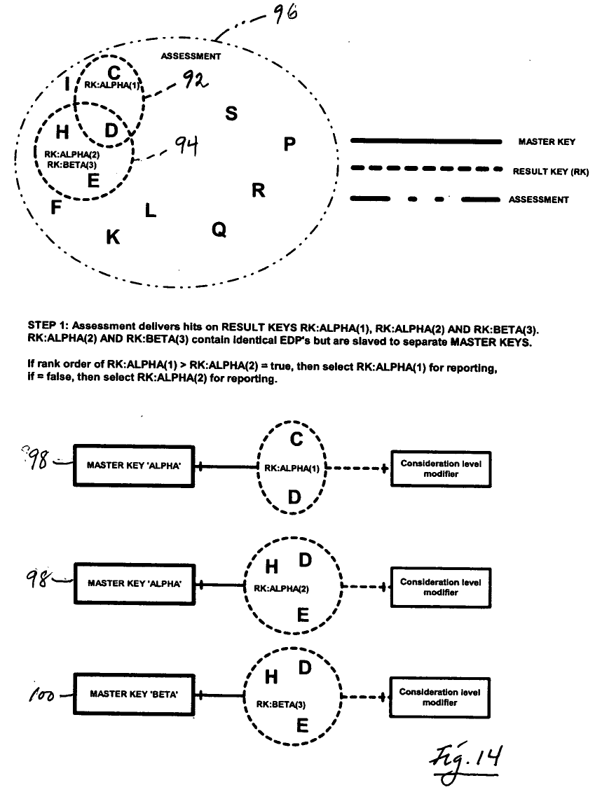

Thus, and in accordance with practice of the improved version of this invention, the mathematical calculation aspect of the invention is performed, as will now be described specifically for Master Key 86, also with respect to Master Keys 88 and 90. A more specific illustration of this multiple Master Key situation will be described a bit later herein with respect to what is shown in FIGS. 14, 15 and 16.

Because of the fact that Result Key 84 has hit Assessment 82, and is specifically slaved to Master Key 86, an overlap comparison is performed to find the region of “EDP overlap” which describes the relationship between Assessment 82 and Master Key 86. It should be noted that positioned within the block in FIG. 12 which represents Master Key 86, and disposed to the right of each of the six EDPs A, B, D, F, G and H which make up this Master Key, there is a number symbol (#). This symbol reflects the “presence” of certain positive or negative integer values which are associated as the mentioned scalar EDP addends assigned, respectively, to each of the EDPs in Master Key 86. These scalar number values are the ones which, as will shortly be seen, are involved in what has been referred to herein as a pair of sum/sum mathematical calculations that are employed to improve the Assessment reporting capability and sophistication of the present invention.

With respect to performing an overlap comparison, or function, in relation to Assessment 82 and Master Key 86, this is illustrated graphically in FIG. 13 where one sees two overlapping circles which are given reference numbers 82, 86 to indicate that they represent, respectively, Assessment 82 and Master Key 86. Within each circle the letter designators for the respectively contained EDPs appear, and the region of overlap is shaded in the center of FIG. 13, and seen to include an overlap of EDPs A, B, D and F.

With these four “overlapping” EDPs identified, one then looks to the EDP addend scalar values in Master Key 86, and thereafter, the mentioned sum/sum calculations are performed, one for all of those particular values of A,B,D and F which are positive, and one for all of those particular A, B, D and F values which are negative. The sum/sum calculations are shown generically and immediately below in the two stated equations which generate power value components X (for positive numbers) and Y (for negative numbers):
ΣEDP(+Addends)=X
ΣEDP(−Addends)=Y

These calculated sum/sum values for X and Y are referred to herein as the determined power values associated with the particular result which is associated with Result Key 84. It is these power values which basically define the level of certainty with respect to which an Assessment report, for example, reporting DX₁ as associated with Result Key 84, will be regarded.

Each Result Key, such as Result Key 84, also has associated with it, or may have associated with it, something which is referred to herein as a qualitative consideration modifier, such as the phrase “extremely rare disease”. In terms of putting out an Assessment report (reportable Assessment) which reports the result associated with Result Key 84, the certainty level is reported in relation to the power value (sum/sum) calculations which have been made. If any consideration modifier exists, such as the one just mentioned above, that modifier is also applied to the relevant Assessment report.

The same calculation procedure just described with respect to looking at the region of EDP overlap between Assessment 82 and Master Key 86 is performed also to look at the respective overlaps in EDPs which exist between Assessment 82 and Master Keys 88, 90, respectively. Power values are calculated with respect to these overlap comparisons, and from the plurality of calculations, if such are performed with respect to a particular set of EDPs involved in a Result Key hit, an appropriate output report of an Assessment is provided, with statements included that relate to the results of these calculations characterized, if applicable, by any appropriate Result Key qualitative consideration modifier.

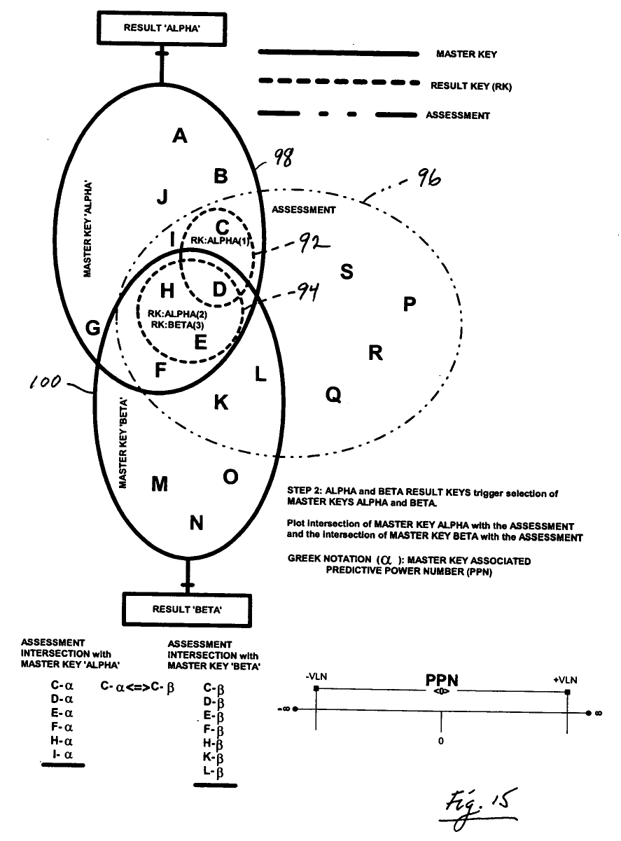

FIGS. 14 and 15, with a considerably greater level of detail, and in a quite self-explanatory way, illustrate two Result Key hits 92, 94 that are associated with a particular Assessment 96. Result Key 92 containing EDPs C and D is a singularity, in the sense that it is associated with only one Master Key shown generally at 98. Result Key 94, however, which contains EDPs H, D and E, in fact defines two different Result Keys, one of which is associated with just-mentioned Master Key 98, and the other one of which is associated with another Master Key 100. The overlap comparisons which are performed here are clearly illustrated graphically in FIG. 15 between Assessment 96 and Master Key 98, and between Assessment 96 and Master Key 100. At the lower left corner in FIG. 15, the respective sets of EDPs contained in the two Master Keys 98, 100, also referred to herein as Master Key “Alpha” and Master Key “Beta”, respectfully, are pictured set next to α and β Greek characters. These characters represent the addend scalar values which are associated with those respective EDPs in each of the two different result-associated Master Keys.

Sum/sum calculations as described above are performed, and X and Y power-value results therefrom, are plotted for the three conditions illustrated in FIGS. 14 and 15, with these three power-value-calculated results pictured as three darkened dots 102, 104, 106 that appear on an X, Y orthogonal graph shown in FIG. 16.

Taking a look at FIG. 16, one will note the presence therein of three differently-sized, shaded rectangles A, B, and C, with rectangle A having a side which is coincident with the Y axis, rectangle B having a side which is coincident with the X axis, and rectangle C being completely spaced from the X and Y axes. The three darkened dots 102, 104, 106 just mentioned, as can be seen, reside within these three shaded rectangles A, B, C, respectively. Other rectangles which are present, as illustrated in FIG. 16, are outlined suggestively only by dash-dot lines, and are not shaded.

Each of these rectangles is referred to herein as a consideration level which will be used to characterize reported Assessments whose associated sum/sum calculations produce data points that “land” within these rectangles. In other words, all power values calculated by the sum/sum procedure described above which fall within rectangle A are treated as being reportable to have the same consideration level with regard to presenting information to a user in a reportable and reported Assessment.

In FIG. 16 since the three mentioned blackened-dot data points fall within regions having different associated consideration levels, in a reported Assessment, all three of these conditions will form portions of that Assessment report. The user who has activated the system and methodology of this invention to generate that reportable Assessment will make a judgment about how to treat, interpret and understand the reported Assessment results.

Shaded rectangles A and B, each of which has one side coincident with one of the axes in FIG. 16, represent consideration levels wherein either the X power value (rectangle A) or the Y power value (rectangle B), turns out to be zero from the sum/sum calculation described above.

As has been suggested earlier, one of the very powerful features of the present invention is that, by using the sum/sum mathematical calculation approach described herein, and recognizing that EDP addend scalar values will be either positive or negative, the system and methodology of this invention is uniquely poised to inform a user not only (a) of the situation that a reported Assessment result of a certain character does positively indicate the likely presence some particular medical condition, but also (b) of the opposite condition—namely that a reported Assessment result does positively indicate the likely absence of a particular medical condition.

### Conclusory Comments

Thus, from a methodology point of view, one will see that the present invention can be described as a computer-based method using an electronic system database which includes database-contained Result Keys, and related, result-associated Master Keys, as a basis for supporting and providing reportable problem and situation result Assessments in a defined field of knowledge, wherein a pre-reportable, preliminary problem or situation result-associated Assessment has been developed, and where Result Keys, and result-associated Master Keys and result Assessments share a common trait involving the defining presence of one or more elemental data components each of which has associated with it a scalar-value addend level. This method includes the steps of: (a) examining, in relation to the system database, the EDP content of the preliminarily-developed, result-associated Assessment to locate any existing Result Key hit(s); (b) with regard to each such located hit, and for the purpose of finding specifically a condition of matching EDP overlap, comparing the EDP content of the preliminary result-associated Assessment with that of each result-associated Master Key which is associated with any Result Key possessing the same EDP content as that of the Result Key(s) which produced the hit(s); (c) with regard to each found, matching EDP overlap, performing a sum/sum mathematical calculation utilizing the scalar-value addend levels associated with the overlapping EDPs, thus to generate a calculated, result-associated power value; and (d), thereafter utilizing such calculated, result-associated power value(s) to produce a reportable result Assessment which is based upon the hits with respect to which the sum/sum mathematical calculation, or calculations, has (have) been performed.

The apparatus and method of the invention are thus now fully described and illustrated in a manner showing the invention's powerful ability to provide problem and/or situation Assessments in any selected knowledge field. And, while a preferred and best mode embodiment and manner of practicing the invention have been expressly set forth herein, we appreciate that variations and modifications are certainly possible, will be discernable by those generally skilled in the relevant art, and may all be made without departing from the spirit of the invention.

We claim:

1. A computer-based method using an electronic database including database-contained Result Keys and related result-associated Master Keys as a basis for supporting and providing reportable problem and situation result Assessments in a defined field of knowledge, wherein a pre-reportable, preliminary problem or situation result Assessment has been developed, and where Result Keys, result-associated Master Keys and result Assessments share a common content trait involving the defining presence of one or more elemental data component(s) (EDPs), each of which EDPs has associated with it a scalar-value addend number, said method comprising
examining, in relation to the database, the EDP content of the preliminary result Assessment to locate any existing Result Key hit(s),
with regard to each such located hit, and to find specifically a condition of matching EDP overlap, comparing the EDP content of the preliminary result Assessment with that of each result-associated Master Key which is associated with any Result Key possessing the same EDP content as that of the Result Key(s) which produced the hit(s),
with regard to each found, matching EDP overlap, performing a sum/sum mathematical calculation utilizing the respective scalar-value addend numbers associated with the overlapping EDPs, thus to generate a calculated, result-associated power value, and
thereafter utilizing such calculated, result-associated power value(s) to produce a reportable result Assessment.

2. The method of claim 1, wherein each Result Key may have associated with it a qualitative consideration modifier, and which further comprises, if a reportable result Assessment is produced which is based, at least in part, upon the existence of a particular Result Key hit, attaching that Result Key's qualitative consideration modifier, if any exists, to the reportable result Assessment

3. In the practice of a method employing a computer-based knowledge system designed for providing problem and situation result Assessments in a defined field of knowledge
providing a database characterized by the diagrams of FIGS. 4 and 5, and
using that provided database, implementing the reportable result Assessment process which is diagrammed in FIGS. 12-15, inclusive.

4. A computer-based knowledge system designed for providing requested problem and/or situation reportable result Assessments in a defined field of knowledge using system-possessed, electronic-database-contained Result Keys and related result-associated Master Keys as a basis for supporting and providing reportable problem and/or situation result Assessments in the mentioned knowledge field, with said system being capable of producing a pre-reportable, preliminary problem and/or situation result Assessment, and where Result Keys, result-associated Master Keys and result Assessments share a common content trait involving the defining presence of one or more database-contained elemental data component(s) (EDPs), each of which EDPs has associated with it a scalar-value addend number, said system comprising,
an input/output communication interface zone,
an output-Assessment-striving knowledge engine, and
intermediary structure operatively interposed said zone and said engine, structured for implementing the method including the steps of
(a) examining, in relation to the database, the EDP content of a system-produced preliminary result Assessment, thus to locate any existing Result Key hit(s),
(b) with regard to each such located hit, and to find specifically a condition of matching EDP overlap, comparing the EDP content of the preliminary result Assessment with that of each result-associated Master Key which is associated with any Result Key possessing the same EDP content as that of the Result Key(s) which produced the hit(s),
(c) with regard to each found, matching EDP overlap, performing a sum/sum mathematical calculation utilizing the respective scalar-value addend numbers associated with the overlapping EDPs, thus to generate a calculated, result-associated power value, and
(d) thereafter utilizing such calculated, result-associated power value(s) to produce a reportable result Assessment.

5. A computer-based method implemented in a system possessing an electronic database including database-contained Result Keys and related result-associated Master Keys as a basis for supporting and providing reportable problem and situation result Assessments in a defined field of knowledge, wherein a pre-reportable, preliminary problem or situation result Assessment has been developed, and where Result Keys, result-associated Master Keys and result Assessments share a common content trait involving the defining presence of one or more elemental data component(s) (EDPs), each of which EDPs has associated with it a scalar-value addend number, said method comprising
for each EDP contained in such a pre-reportable, preliminary result Assessment, locating all results known in the system containing that EDP,
for each such located result, identifying the Master Key associated with the located result,
in relation to each such identified Master Key, looking for a related Result Key hit, and
following said looking, progressing the pre-reportable, preliminary Assessment toward a reportable result Assessment, including performing a set of mathematical calculations involving the scalar-value addend numbers which are associated with EDPs contained in any Result Keys involved in producing such a Result Key hit.
